(19) United States
(12) Patent Application Publication
(10) Pub. No.: US 2008/0195734 A1
(43) Pub. Date: Aug. 14, 2008

(54) Method of using portable network-attached storage

(76) Inventor: Shih-Ho Hong, Taipei City (TW)

Correspondence Address: SHIH-HO HONG, 20525 Via Talavera, Yorba Linda, CA, 92887, US

(21) Appl. No.: 11/704,445

(22) Filed: Feb. 12, 2007

(51) Int. Cl. G06F 15/173

(52) U.S. Cl. 709/226

(57) ABSTRACT

A method of using portable network-attached storage includes the steps of (1) providing a user with a portable network-attached storage; (2) coupling the portable network-attached storage into an electronic apparatus, so that the portable network-attached storage is linked with a remote network host; (3) performing a storage unit in the remote network storage host to form a virtual disk via a network unit of the portable network-attached storage; and (4) performing file processing by the electronic apparatus for a file in the virtual disk or the portable network-attached storage. In this manner, the easy-carry portable network-attached storage may be linked with a virtual disk in the remote network host via an electronic apparatus, allowing a user to advantageously utilize the large capacity of the network hard disk, and making the portable network-attached storage more practical for use.

### FIELD OF THE INVENTION

The present invention relates to a method of using portable network-attached storage, and more particularly to a method of linking a portable network-attached storage with a remote network host to enable data processing at any place at any time.

### BACKGROUND OF THE INVENTION

In an existing method of using a network virtual disk drive, a software interface is installed on a user's computer, so that a network disk provided by an internet service provider may be linked with the user's computer. This method would largely lower the convenience in using a network virtual disk because only the computer having the software interface installed thereon may use the storage space on the network disk. Therefore, the user could not utilize the network disk via other computer and has to carry about a notebook computer having the software interface installed thereon. However, the notebook computer is not so convenient for carrying about due to its weight.

Therefore, it is desirable to develop a method of using portable network-attached storage, so that an easy-carry portable network-attached storage may be linked with a large-capacity virtual disk in a remote network host via an electronic apparatus to enable data processing at any place at any time.

### SUMMARY OF THE INVENTION

A primary object of the present invention is to provide a method of using portable network-attached storage, so that a user may advantageously utilize the easy-carry portable network-attached storage and the large capacity of a network hard disk to conveniently perform file and data processing.

To achieve the above and other objects, the method of using portable network-attached storage according to the present invention includes the following steps:
(1) providing a portable network-attached storage, which has a virtual disk simulating unit and a network unit;
(2) Coupling an interface unit of the portable network-attached storage to an electronic apparatus, so that the portable network-attached storage is linked with a remote network host via the network unit;
(3) performing least one storage unit in the remote network host to form at least one virtual disk via the virtual disk simulating unit; and
(4) performing at least one file processing by the electronic apparatus for at least a first file in the virtual disk or at least a second file in the portable network-attached storage.

In this manner, the easy-carry portable network-attached storage may be linked with a virtual disk in the remote network host, allowing a user to advantageously utilize the large capacity of the network hard disk, and making the portable network-attached storage more practical for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a method of using portable network-attached storage according to a first preferred embodiment of the present invention;

FIG. 2 is a flowchart showing the steps included in a method of using portable network-attached storage according to a second preferred embodiment of the present invention;

FIG. 3 shows a preferred example of using a portable network-attached storage in a wireless network system with the method of the present invention; and

FIG. 4 shows a preferred example of using a portable network-attached storage in a wired network system with the method of the present invention.

### DETAILED DESCRIPTION OF THE PREFERRED EMBODIMENTS

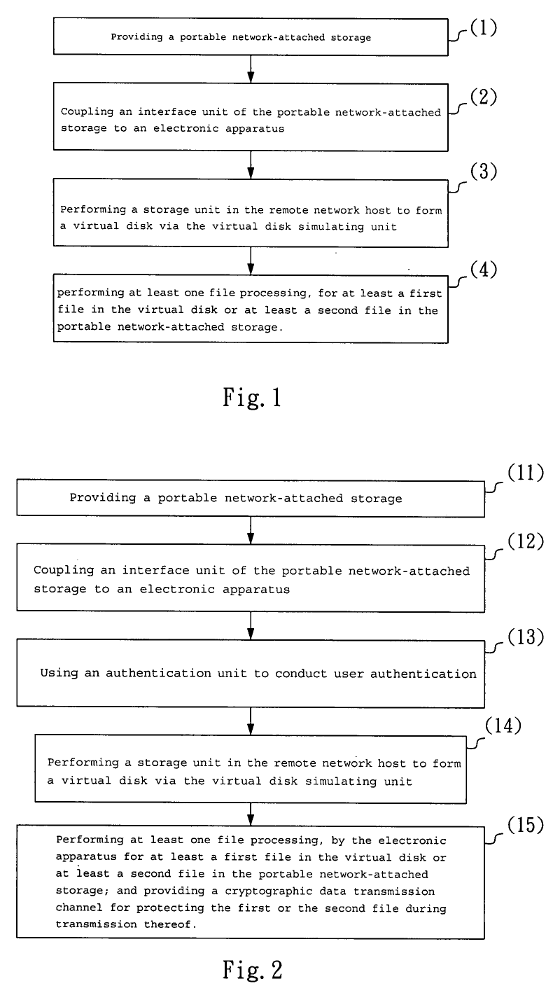

Please refer to FIG. 1 that is a flowchart showing the steps includes in a method of using portable network-attached storage according to a first preferred embodiment of the present invention. As shown, the steps of the method in the first embodiment include:
(1) Providing a portable network-attached storage, including, but not limited to, a universal serial bus (USB) flash disk, a compact flash (CF) card, an secure digital (SD) card, or an XD Picture Card (XD) card; wherein the portable network-attached storage has a virtual disk simulating unit and a network unit that may be a wired network chip or a wireless network chip;
(2) Coupling an interface unit of the portable network-attached storage to an electronic apparatus, so that the portable network-attached storage is linked with a remote network host via the network unit; wherein the interface unit may include, but not limited to, a USB interface, an SD interface, a compact flash CF interface, an XD interface, a Personal Computer Memory Card International Association (PCMCIA) interface, a 1394 interface, an infrared interface, or a Bluetooth interface; and the electronic apparatus may include, but not limited to, a desktop computer, a notebook computer, a digital camera, or a personal digital assistant (PDA)
(3) Performing a storage unit in the remote network host to form a virtual disk via the virtual disk simulating unit; and
(4) performing at least one file processing, including, but not limited to, overwriting, copying, deleting, editing, browsing, altering file name, or modifying file attribute, by the electronic apparatus for at least a first file in the virtual disk or at least a second file in the portable network-attached storage.

FIG. 2 is a flowchart showing the steps included in a method of using portable network-attached storage according to a second preferred embodiment of the present invention. As shown, the steps of the method in the second embodiment include:
(11) Providing a portable network-attached storage, including, but not limited to, a USB flash disk, a CF card, an SD card, or an XD card; wherein the portable network-attached storage has a virtual disk simulating unit and a network unit that may be a wired network chip or a wireless network chip;
(12) Coupling an interface unit of the portable network-attached storage to an electronic apparatus, so that the portable network-attached storage is linked with a remote network host via the network unit; wherein the interface unit may include, but not limited to, a USB interface, an SD interface, a CF interface, an XD interface, a PCMCIA interface, a 1394 interface, an infrared interface, or a Bluetooth interface; and the electronic apparatus may include, but not limited to, a desktop computer, a notebook computer, a digital camera, or a PDA;
(13) Using an authentication unit to conduct user authentication, including, but not limited to, password authentication, fingerprint authentication, or voice authentication;
(14) Performing a storage unit in the remote network host to form a virtual disk via the virtual disk simulating unit; and
(15) Performing at least one file processing, including, but not limited to, overwriting, copying, deleting, editing, browsing, altering filename, or modifying file attribute, by the electronic apparatus for at least a first file in the virtual disk or at least a second file in the portable network-attached storage; and providing a cryptographic data transmission channel for protecting the first or the second file during transmission thereof.

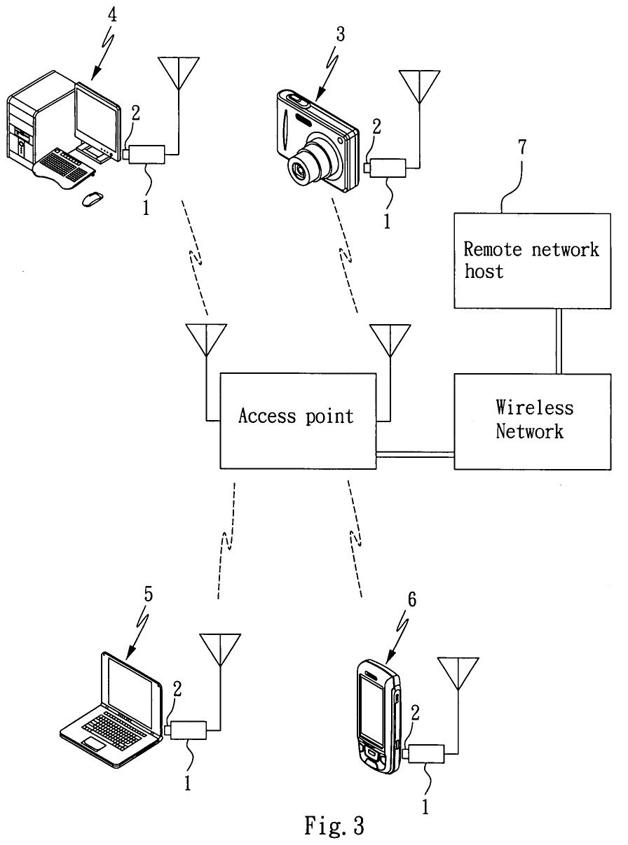

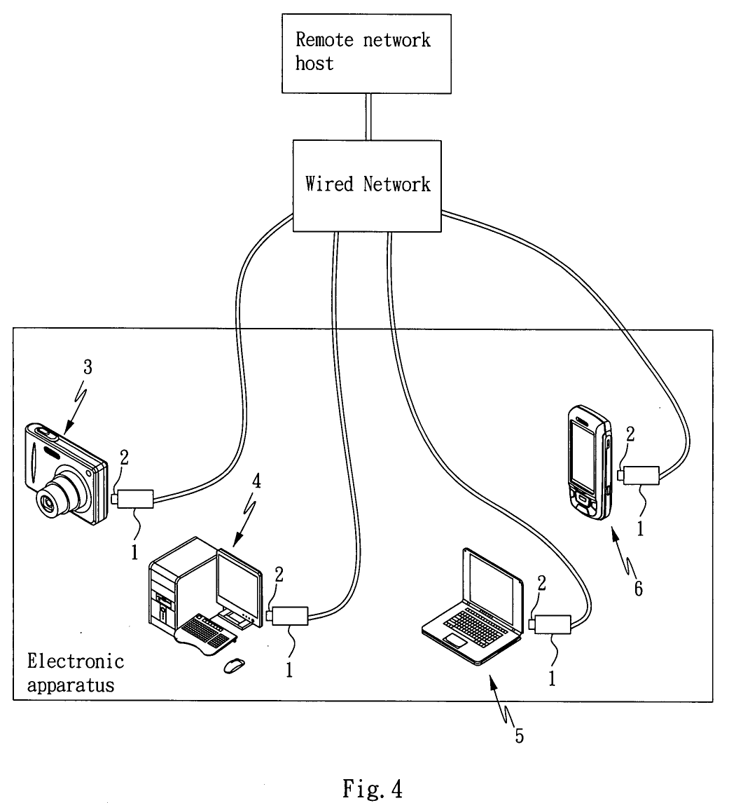

FIGS. 3 and 4 show two preferred examples of using a portable network-attached storage in a wireless and a wired network system, respectively, with the method of the present invention. As shown, a portable network-attached storage 1, which may include, but not limited to, a USB flash disk, a CF card, an SD card, or an XD card, is provided for coupling to an electronic apparatus, such as a digital camera 3, a personal computer 4, a notebook computer 5, a PDA 6, an MP3 player, or a voice pen, via an interface unit 2, so that the portable network-attached storage 1 may be linked with a remote network host 7 via a network unit, such as a wired network chip or a wireless network chip provided in the portable network-attached storage 1. Then, an authentication unit (not shown) is used to conduct user authentication by way of password authentication, fingerprint authentication, or voice authentication. Thereafter, a storage unit (not shown) in the remote network host 7 is caused to form a virtual disk, such as a virtual hard disk (not shown), via a virtual disk simulating unit (not shown) in the portable network-attached storage 1. Wherein, the size of the virtual disk available for a user is determined through a payment gateway. Finally, a file processing is performed by the electronic apparatus for a first file in the virtual disk or a second file in the portable network-attached storage 1. The file processing may include, but not limited to, overwriting, copying, deleting, editing, browsing, altering filename, or modifying file attribute. Moreover, a cryptographic data transmission channel (not shown) and a server firewall are provided for protecting the first or the second file against virus infection during transmission thereof.

As an example, the use of the portable network-attached storage 1 with a digital camera 3 with the method of the present invention is now further described. In an environment with a wireless network, the digital camera 3 is coupled to the portable network-attached storage 1, and photos taken by using the digital camera 3 may be directly stored on one of virtual hard disks in a remote network host 7 via the wireless network. Therefore, the available storage capacity of the digital camera 3 may be effectively increased. On the other hand, when the digital camera 3 is used in an environment without any available network, the photos having been taken may be temporarily stored on the portable network-attached storage 1. The photos stored in the portable network-attached storage 1 may be transmitted to and stored on one of the virtual hard disks in the remote network host 7 as soon as a network environment is available.

As another example, the use of the portable network-attached storage 1 with a general computer 4 with the method of the present invention is now further described. A user may connect the portable network-attached storage 1 to any computer 4 or electronic apparatus owned by others, and computer operation may be executed at any place at any time via the computer 4 or the electronic apparatus to store any computer file on one of the virtual hard disks in a remote network host 7. In this manner, the user need not carry a clumsy notebook computer about, and would not be restricted to a specific computer to use the remote network host 7.

The method of the present invention is novel and improved because it enables the easy-carry portable network-attached storage to be linked with a virtual disk in the remote network host via an electronic apparatus, allowing a user to advantageously utilize the large capacity of the network hard disk, and making the portable network-attached storage more practical for use. The method of the present invention also has good industrial applicability because products derived from the present invention would no doubt fulfill the current market demands.

What is claimed is:

1. A method of using portable network-attached storage, comprising the following steps:
(1) providing a portable network-attached storage which has a virtual disk simulating unit and a network unit;
(2) Coupling an interface unit of the portable network-attached storage into an electronic apparatus, so that the portable network-attached storage is linked with a remote network host via the network unit;
(3) Providing at least one storage unit in the remote network host to form at least one virtual disk via the virtual disk simulating unit; and
(4) Performing at least one file processing for at least a first file in the virtual disk or at least a second file in the portable network-attached storage on the electronic apparatus.

2. The method of using portable network-attached storage as claimed in claim 1, wherein the step (2) further includes the following step:
(21) using an authentication unit to conduct user authentication.

3. The method of using portable network-attached storage as claimed in claim 1, wherein the step (4) further includes the following step:
(41) providing a cryptographic data transmission channel for protecting the first and the second file during transmission thereof.

4. The method of using portable network-attached storage as claimed in claim 1, wherein the portable network-attached storage is selected from the group consisting of a USB flash disk, a CF card, an SD card, and an XD card.

5. The method of using portable network-attached storage as claimed in claim 1, wherein the network unit is selected from the group consisting of a wired network chip and a wireless network chip.

6. The method of using portable network-attached storage as claimed in claim 1, wherein the interface unit is selected from the group consisting of a USB interface, an SD interface, a CF interface, an XD interface, a PCMCIA interface, a 1394 interface, an infrared interface, and a Bluetooth interface.

7. The method of using portable network-attached storage as claimed in claim 1, wherein the electronic apparatus is selected from the group consisting of a desktop computer, a notebook computer, a digital camera, and a PDA.

8. The method of using portable network-attached storage as claimed in claim 1, wherein the file processing is selected from the group consisting of overwriting, copying, deleting, editing, browsing, altering file name, and modifying file attribute.

9. The method of using portable network-attached storage as claimed in claim 2, wherein the authentication unit conducts user authentication in a manner selected from the group consisting of password authentication, fingerprint authentication, and voice authentication.
